(19) United States
(12) Patent Application Publication
(10) Pub. No.: US 2006/0229961 A1
(43) Pub. Date: Oct. 12, 2006

(54) Risk evaluation method and system using ACH data

(75) Inventors: Rick B. Lyftogt, Phoenix, AZ (US); Robert Evans, Scottsdale, AZ (US)

Correspondence Address: MICHAEL BEST & FRIEDRICH, LLP, 100 E WISCONSIN AVENUE, MILWAUKEE, WI, 53202, US

(73) Assignee: eFunds Corporation, Scottsdale, AZ (US)

(21) Appl. No.: 11/102,391

(22) Filed: Apr. 8, 2005

(51) Int. Cl. G06Q 40/00; G06F 7/00; G06F 17/00

(52) U.S. Cl. 705/35; 705/42; 705/43; 707/100

(57) ABSTRACT

A method and system of managing risk associated with a financial transaction. In one embodiment, the method comprises receiving data associated with a plurality of past transactions. The received data includes Automated Clearing House (ACH) data and other payment-related data. The method further comprises storing the received data in a database; receiving a risk management request in connection with a new transaction; analyzing the stored data based at least in part on the risk management request; and generating a risk management indication.

### FIELD

The invention relates generally to risk management issues in transactions. In particular, embodiments of the invention relate to methods and systems of managing risk associated with a financial transaction.

### BACKGROUND

The Automated Clearing House (ACH) is a secure payment transfer system that connects all U.S. financial institutions. The ACH network acts as the central clearing facility for ACH electronic fund transfer (EFT) transactions that occur nationwide. The ACH network is often used in connection with point-of-purchase, telephone, and Internet transactions. In ACH transactions, the originator and the originating depository financial institution (ODFI) are at risk due to fraud. ACH fraud categories include unauthorized transactions, returns/60-day right of recredit, real time online account number verification, ACH returns due to invalid account numbers, fraudulently used valid account numbers, closed accounts, and non-sufficient funds (NSF).

### SUMMARY

The following summary sets forth certain exemplary embodiments of the invention. It does not set forth all such embodiments and should not be construed as limiting of embodiments of the invention.

In one embodiment, a method of managing risk associated with a financial transaction comprises receiving data associated with a plurality of past transactions. The received data includes Automated Clearing House (ACH) data and other payment-related data. The method further comprises storing the received data in a database; receiving a risk management request in connection with a new transaction; analyzing the stored data based at least in part on the risk management request; and generating a risk management indication.

In another embodiment, a system of managing risk associated with a financial transaction comprises a data acquisition application and a data analysis application. The data acquisition application is configured to receive data associated with a plurality of past transactions. The received data includes ACH data and other payment-related data. The data acquisition application is further configured to store the received data in a database. The data analysis application is configured to analyze the stored data based at least in part on a risk management request received in connection with a new transaction. The data analysis application is further configured to generate a risk management indication.

Other aspects of the invention will become apparent by consideration of the detailed description and accompanying drawings.

### BRIEF DESCRIPTION OF THE DRAWINGS

FIG. 1 shows a system according to an embodiment of the invention.

FIG. 2 shows a risk management system according to an embodiment of the invention.

FIG. 3 shows exemplary data stored by a database of a risk management system according to an embodiment of the invention.

FIG. 4 shows a process according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Embodiments of the invention relate to methods and systems of managing risk associated with a transaction, such as a transaction between a payor and a payee. The payor and payee each may be a consumer, business, or other organization. The transaction may be a commercial transaction (e.g., retail or business-to-business, B2B) or a noncommercial transaction.

In one embodiment, data associated with past Automated Clearing House (ACH) transactions, and optionally other data, is gathered and stored in a database. The database provides associations between, for example, account numbers, names, and addresses, and optionally includes related transactional history. In conjunction with a new transaction, the stored data is analyzed to help assess the degree of risk associated with the new transaction, thereby providing an early warning to one or more participants in the transaction. The risk assessment can provide, for example, an indication of the likelihood that payment will be made, or an indication of confidence that an authorized user is participating in the transaction. Based on the risk assessment, appropriate action can be taken. For instance, if a presented name and account do not match up with data stored in the database, the new transaction may be declined as fraudulent. If the payor has a history of delinquency, the transaction may be put on hold, another form of payment may be required, the payor's account activity may be monitored, and/or payment may be reversed. Embodiments herein can, among other things, thwart fraudulent activity and identify transactions involving users with poor payment histories, thereby reducing risks in the payment process.

In one embodiment, ACH and other payment-related data is contributed to the database by numerous participants in e-commerce transactions. For instance, data associated with a participant's payment processing operations can be contributed by the participant. In exchange (or partial exchange) for contributing the data, the participant can request risk assessment information for a new transaction involving the participant.

Embodiments can involve any of various parties, such as, for example, remittance processors, retailers or service companies (e.g., utility, cable, telephone companies) handling their own remittance processing, other companies or organizations that process credit account payments (credit cards, line of credit accounts, etc.), other ACH processors, companies providing Internet financial account services, online bill payment companies, companies providing telephone/VRU (voice response unit) solutions, and insurance companies.

Embodiments herein can remedy limitations of the ACH network. For instance, embodiments provide a risk management mechanism that can remedy the following limitations: no real time authorization mechanism (i.e., Status of Account—Open/Closed/Never Existed), unauthorized transactions, real time online account number verification, no match between account numbers and names, ACH returns due to invalid account numbers, lack of standardized account number structure, fraudulently used valid account numbers, closed accounts, and non-sufficient funds (NSF).

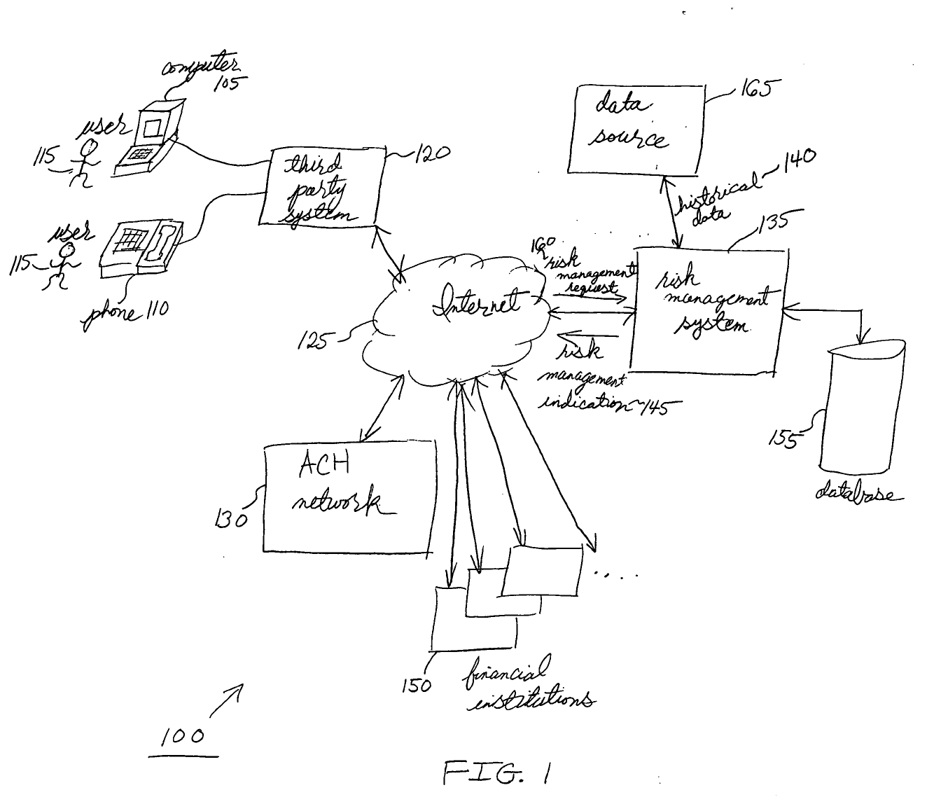

FIG. 1 shows a system 100 according to an embodiment of the invention. The system 100 includes a third party system 120, a risk management system 135, a database 155, an ACH network 130, financial institutions 150, and a data source 165. Various modules in the system 100 communicate over the Internet 125 or other suitable networks. Although one third party system 120 and one data source 165 are shown, an arbitrary number of such third party systems 120 and data sources 165 can operate within the system 100. It is to be appreciated that FIG. 1 is shown in simplified form for illustrative purposes; other modules and/or networks can be included. Moreover, modules shown in FIG. 1 can be implemented in combinations of hardware and/or software. For instance, the database 155 can be implemented as multiple databases.

The third party system 120 enables users 115 to participate in transactions. For instance, the third party system 120 can include a web server enabling users 115 to purchase goods or services or to pay for goods previously provided or services previously rendered. A user 115 communicates with the third party system 120 by any suitable means, such as, for example, a computer 105 (e.g., via an Internet connection) or a phone 110 (e.g., via a VRU of the third party system 120). The third party system 120 is configured to communicate with the ACH network 130, which in turn communicates with financial institutions 150 to effect electronic credit and debit transfers in connection with transactions.

The risk management system 135 receives historical data 140, such as ACH data and/or other payment-related data, from the data source 165 (e.g., a remittance processor). In one embodiment, the data source 165 is also a third party system 120. The historical data 140 can be received over a network (e.g., the Internet 125) or locally (e.g., from computer-readable media). In one embodiment, the historical data 140 is received as one or more batch files and is stored in the database 155. Some or all the received data can be preprocessed before being stored. In one embodiment, data sources 165 provide historical data 140 generated in connection with transactions involving the data sources 165. The risk management system 135 analyzes such data to provide a risk management indication 145 for a new transaction, as described in further detail below.

In one embodiment, the database 155 includes (1) a database of account numbers including raw MICR and ACH account numbers and routing & transit numbers (R&Ts); (2) a database of ACH transactions; and/or (3) a database of ACH return items. The database of ACH return items may flag NSF, Uncollected, and Account Closed situations (reflecting risk issues); administrative and UTL situations (reflecting possible MICR to ACH conversion problems or fraud); and/or NOC (Notification of Change) situations. In an embodiment, the data in the database 155 is sufficiently accurate so as to be usable for analysis.

In an exemplary scenario, a user 115 participates in a transaction with the third party system 120. Some time before the transaction is consummated (e.g., before a user can purchase an item or before a transfer of funds is attempted), the third party system 120 sends a risk management request 160 to the risk management system 135 in connection with the transaction. The risk management request 160 may be sent via a message, by logging into the risk management system 135, and/or by other suitable means. The risk management system 135 analyzes stored data in the database 155 and generates a risk management indication 145, which provides an assessment of the degree of risk associated with the transaction. In an exemplary implementation, risk management analyses are undertaken during origination of a new transaction (e.g., before applying payment to an account), during returns processing, and/or at other times. The risk management system 135 sends the risk management indication 145 to the third party system 120. Based on the risk management indication 145, the third party system 120 allows the transaction to proceed, terminates the transaction without issuing a request to transfer funds, and/or puts the transaction on hold for a period of time, for example. The third party system 120 can include a decision engine (not shown) to determine an appropriate course of action based on the risk management indication 145 and other factors.

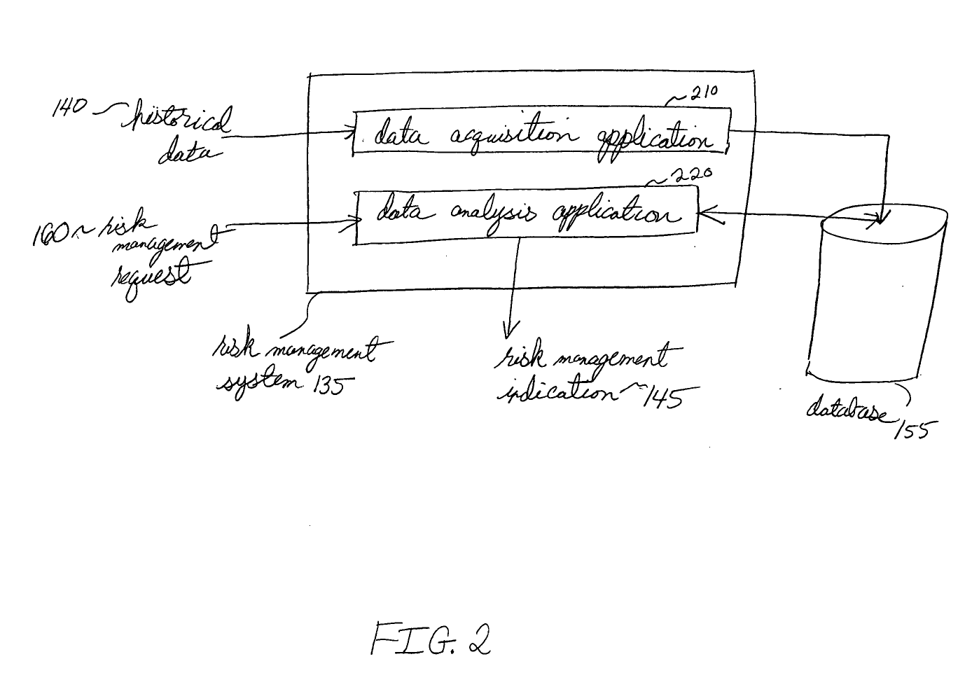

FIG. 2 shows an exemplary embodiment of the risk management system 135. The risk management system 135 includes a data acquisition application 210 and a data analysis application 220. The data acquisition application 210 receives historical data 140 and stores some or all the data in the database 155. The historical data 140 includes ACH data and/or other payment-related data, such as data derived from processing of a physical check (e.g., raw MICR data) or accountholder names, addresses, phone numbers, e-mail addresses, primary account numbers (PANs), and/or payment history (e.g., provided by a user or otherwise acquired in connection with a past transaction).

The data acquisition application 210 optionally preprocesses (e.g., parses and/or reformats) the data before storing it in the database 155. In an exemplary implementation, data is received by the data acquisition application 210 as a file conforming to a standard input file format. An exemplary file format includes monetary and background information in the same file. An exemplary file includes information associated with approximately 25,000 to 50,000 transactions.

Data for the risk management system can be gathered from various parties and in various ways. For instance, name, address, and account number information can be gathered from check printer order data or from remittance processors. Remittance processors, such as cable companies, utility companies, and telephone companies or agents thereof, can acquire an image of a check from a check reader sorter and can derive name, address, and raw MICR information from the check or the image thereof. Internet and telephone originators also can provide data (e.g., name, address, and checking information), as well as companies that employ customer loyalty programs.

The data analysis application 220 receives a risk management request 160. The risk management request 160 includes information pertinent to a new transaction, such as, for example, account information, account holder information, and/or amount. Based on the information in the risk management request 160, the data analysis application 220 analyzes the data stored in the database 155 to generate a risk management indication 145. The data analysis can be partially or entirely performed prior to receipt of the risk management request 160 and/or on-the-fly in response to receipt of the risk management request 160. In an alternative implementation, the data analysis application 220 is operated by a third party that remotely accesses the database 155.

The data analysis application 220 may employ any among a host of analytical processes. For instance, an exemplary data analysis application 220 can determine whether account and name information in the risk management request 160 is consistent with data stored in the database 155. Alternatively or additionally, the data analysis application 220 can determine whether an accountholder has a history of delinquency. The risk management indication 145, which may be quantitative and/or qualitative, provides an indication of the degree of risk associated with the new transaction. Exemplary risk management indications 145 include a score, a confidence level indicator, and/or a flag. In one embodiment, the risk management system 135 sends the risk management indication 145 to the party that issued the risk management request 160.

In one embodiment, the risk management indication 145 indicates the probability of payment being made in connection with a new transaction. Such probability may be based on an analysis of the historical data stored in the database 155, and can consider, for example, whether items have been returned (e.g., NSF or Uncollected), and/or recent payment history (e.g., Is an account going downhill?). The data analysis application 220 optionally accesses databases external to the database 155, such as account closed databases, check payment or NSF history databases, velocity databases, and/or deceased databases. Alternatively or additionally, data in such databases can be stored in the database 155.

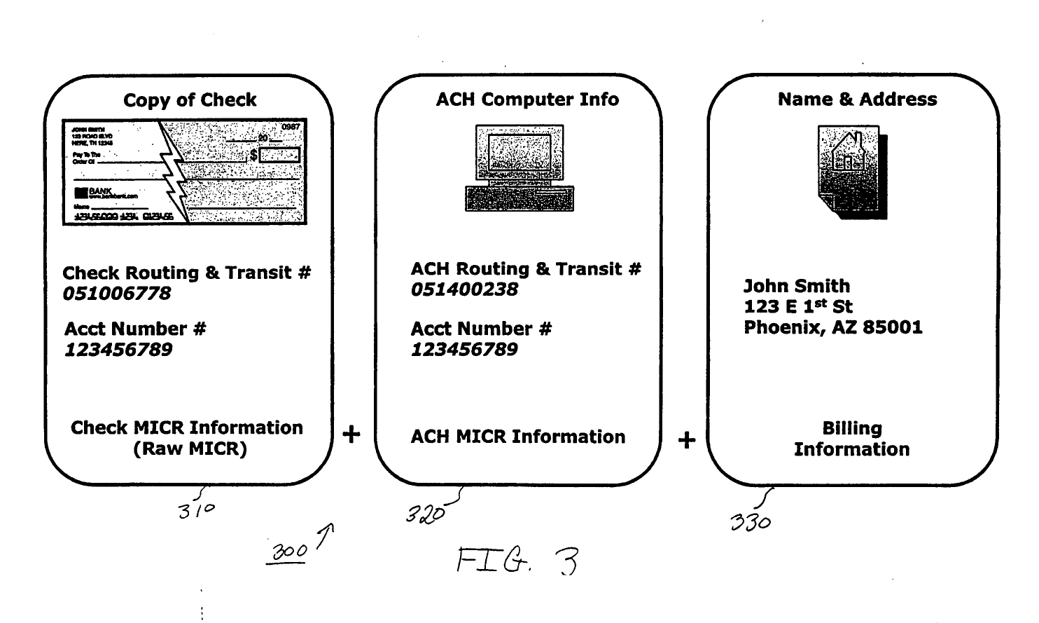

FIG. 3 shows exemplary data 300 stored by a database of a risk management system according to an embodiment of the invention. As shown, the data 300 includes check MICR information 310, ACH MICR information 320, and/or billing information 330. The database need not include all the kinds of data shown, and can include other kinds of data, such as shipping information.

The check MICR information 310 includes check MICR (raw MICR) information, which can be derived from a check or from a digital image thereof. A digital image of the check, a digital image of the signature, the check routing & transmit number, account number, name(s), address, and/or phone number(s) also can be stored by the database. To derive information, MICR, OCR, and/or image processing techniques can be applied in accordance with the art. Additionally, the raw MICR information can be converted to ACH MICR format and stored. The ACH MICR information 320 includes information associated with ACH computer transactions, including ACH routing & transit number and/or account number. The billing information 330 includes name and address of a party to a transaction.

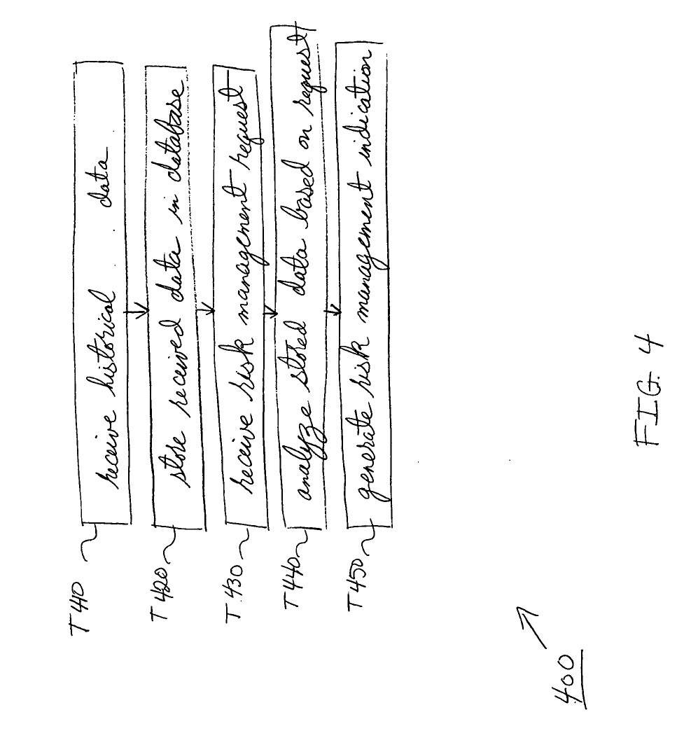

FIG. 4 shows a process 400 according to an embodiment of the invention. The process 400 can be used, for example, by the risk management system 135 of FIGS. 1 and 2. Task T410 receives historical data, such as historical check data and/or ACH data. Task T420 stores the received data in a database. Task T430 receives a risk management request in connection with a new transaction, such as a check-based transaction (e.g., mail, lockbox, dropbox) or a check replacement transaction (e.g., Web, telephone). Task T440 analyzes the stored data based on the request. Task T450 generates a risk management indication. The indication may be sent to, or retrieved by, a party, such as a party that sent the risk management request received in task T430. In one embodiment (not shown), a party is charged for risk management information. The charging may be transactional, based on a flat fee, and/or reduced based on historical data contributed by the party, for example.

Embodiments herein can operate in real time and/or in batch mode. In real time, a risk management system can provide a risk management indication at the time a user is participating in a transaction (e.g., when the user is online). Exemplary real time applications include point-of-purchase (POP) payments and purchases, Internet payments and purchases (web initiated entry, WEB), telephone payments and purchases (telephone initiated entry, TEL), and recurring payment setups and changes. In batch mode, a risk management system can provide a risk management indication when the user is not participating in a new transaction (e.g., when the user is offline). An exemplary batch mode application is remittance processing for large volume remittances (e.g., accounts receivable entries, ARC, in backroom/ backoffice or other settings).

More particularly, embodiments herein can be used in real time or in batch mode to help identify fraud involving a user taking over the account of another. Embodiments are applicable, for instance, to Internet enrollment processing, one-off Internet shopping, batch ACH processing, and loyalty programs with linked ACH payment capability. Internet enrollment processing occurs when a consumer establishes a relationship with a service provider (e.g., a brokerage, bank, utility company, or credit issuing company) and sets up an account (or multiple accounts) from another institution to transfer funds. One-off Internet shopping occurs where no formal relationship has been established with the consumer; rather, the consumer makes a purchase by e-check (the consumer keys account and bank routing information). Batch ACH processing occurs during the ACH origination process. Loyalty programs with linked ACH payment capability provide a consumer with the ability to make an ACH payment using a loyalty card.

In these varied contexts, a risk management system can generate a risk management indication to assist a third party in validating a user who is attempting to enter a transaction with the third party. For instance, ACH MICR and name data provided by the user can be compared against associations stored in a database. The risk management indication indicates, for example, whether a match exists; whether a mismatch exists; and whether no match was found. The third party optionally can request additional challenge information from the user (e.g., driver's license number, address, phone number, etc.) to validate the user. In an exemplary implementation, a risk management indication includes a confidence level indicator in the form of a three-digit score or a High, Medium, Low indicator. The third party optionally sends the risk management system a file of returns to enable the risk management system to assess the accuracy of the information it provided and to adjust its scoring accordingly. In another exemplary implementation, the risk management system identifies whether a given account is a commercial DDA account; whether the same account has been used to pay multiple credit card accounts; the number of payments that have been made on a particular card in a specified number of days; the accounts that have been used to pay on this card account; whether the accountholder for this account is deceased; the number of returns in a specified time period; and the frequency of returns.

It is to be appreciated that validation embodiments herein can validate a user without requiring challenge deposits to a consumer's checking account and without requiring that a consumer mail a voided check to a service provider. When used in conjunction with enrollment processes, such steps can cause many users to abandon the processes.

Embodiments herein can be applied to assess the risk of transactions involving consumer payments that are sent to a lockbox or dropbox for conversion into an ACH electronic debit. In batch mode, the risk management system analyzes stored data to validate name to account number, consider whether the account is closed, consider the history of returns (NSFs) for the account, and/or determine a probability of payment. Upon receiving a risk management indication indicative of a problem, the payee (or agent thereof) can flag the account, put on hold the application of payment, or take other appropriate action. Analogous approaches can be undertaken for real time phone payments, setup of recurring Internet payments, and setup of an Internet payment profile, for example.

In an exemplary origination scenario, during the first 90 days (or other period) of a new account for a user, a retailer requests information from a risk management system in order to determine whether to make available the user's credit line for the amount of a new payment or to hold the line as is for a hold period to ensure that a previous payment will be honored. In an exemplary returns processing scenario, if a remittance processor would like to resubmit a returned item, the processor requests information from a risk management system to enable the processor to determine whether to charge back the item while waiting for the results of the resubmission.

Embodiments herein can be optionally used in conjunction with other risk management approaches, such as, for example, check authorization and guarantee models, positive and negative databases, velocity filters, PIN and signature based (credit and debit cards) models, neural networks and other predictive models, item processing solutions for deposited checks, and account access validation programs (e.g., merchant originates small dollar transactions to make customers prove that they have access to an account).

Although certain embodiments herein involve the ACH network and related data, it is to be appreciated that other embodiments of a risk management system and method can receive and analyze data associated with other electronic fund transfer networks.

As should be apparent to one of ordinary skill in the art, the systems shown in the figures are models of what actual systems might be like. Many of the modules and logical structures described above are capable of being implemented in software executed by a microprocessor or a similar device or of being implemented in hardware using a variety of components including, for example, application specific integrated circuits (“ASICs”). Thus, the claims should not be limited to the specific examples or terminology or to any specific hardware or software implementation or combination of software or hardware. Various features and advantages of the invention are set forth in the following claims.

What is claimed is:

1. A method of managing risk associated with a financial transaction, the method comprising the acts of:
receiving data associated with a plurality of past transactions, the received data including Automated Clearing House (ACH) data and other payment-related data;
storing the received data in a database;
receiving a risk management request in connection with a new transaction, the risk management request including account or accountholder information;
analyzing the stored data based at least in part on the risk management request; and
generating a risk management indication.

2. The method of claim 1, wherein the ACH data comprises routing & transit numbers and account numbers.

3. The method of claim 1, wherein the payment-related data comprises raw MICR information.

4. The method of claim 1, wherein the payment-related data comprises accountholder names and accountholder addresses.

5. The method of claim 1, wherein the payment-related data comprises historical payment information for accounts or accountholders.

6. The method of claim 5, wherein the historical payment information relates to forward items or return items.

7. The method of claim 1, further comprising the act of sending the risk management indication to a third party.

8. The method of claim 7, further comprising the act of charging the third party for the risk management indication.

9. The method of claim 1, wherein the indication comprises a score.

10. The method of claim 9, wherein the score comprises a probability.

11. The method of claim 1, wherein the indication is associated with a user validation process.

12. The method of claim 1, wherein the received data is sent by a third party.

13. The method of claim 12, wherein the third party is a remittance processor.

14. The method of claim 1, wherein the new transaction is originated over the Internet.

15. The method of claim 1, wherein the new transaction relates to a recurring payment.

16. The method of claim 1, wherein the risk management request is received in a batch mode.

17. The method of claim 1, wherein the risk management request is received in real time.

18. The method of claim 1, wherein the act of analyzing the stored data comprises determining recent payment history of an account.

19. The method of claim 1, wherein the act of analyzing the stored data comprises accessing at least one of account closed information, check payment or NSF (non-sufficient fund) history information, or deceased accountholder information.

20. The method of claim 1, wherein the data is received in a standard file format.

21. The method of claim 1, wherein the new transaction is originated by telephone.

22. A system of managing risk associated with a financial transaction, the system comprising:
a data acquisition application configured to receive data associated with a plurality of past transactions and to store the received data in a database, the received data including Automated Clearing House (ACH) data and other payment-related data; and
a data analysis application configured to analyze the stored data based at least in part on a risk management request, the risk management request being received in connection with a new transaction and including account or accountholder information, the data analysis application being further configured to generate a risk management indication.

23. The system of claim 22, further comprising the database.

24. A computer-readable medium encoded with a plurality of processor-executable instructions for:
receiving data associated with a plurality of past transactions, the received data including Automated Clearing House (ACH) data and other payment-related data;
storing the received data in a database;
receiving a risk management request in connection with a new transaction, the risk management request including account or accountholder information;
analyzing the stored data based at least in part on the risk management request; and
generating a risk management indication.

25. A system of managing risk associated with a financial transaction, the system comprising:
means for receiving data associated with a plurality of past transactions, the received data including Automated Clearing House (ACH) data and other payment-related data;
means for storing the received data in a database;
means for receiving a risk management request in connection with a new transaction, the risk management request including account or accountholder information;
means for analyzing the stored data based at least in part on the risk management request; and
means for generating a risk management indication.
